(19) United States
(12) Patent Application Publication
(10) Pub. No.: US 2023/0316087 A1
(43) Pub. Date: Oct. 5, 2023

(54) SERVING DISTRIBUTED INFERENCE DEEP LEARNING (DL) MODELS IN SERVERLESS COMPUTING

(71) Applicant: Meta Platforms, Inc., Menlo Park, CA (US)

(72) Inventors: Kunal MAHAJAN, Fremont, CA (US); Rumit Amitbhai Desai, Fremont, CA (US)

(73) Assignee: Meta Platforms, Inc., Menlo Park, CA (US)

(21) Appl. No.: 18/080,569

(22) Filed: Dec. 13, 2022

Related U.S. Application Data
(60) Provisional application No. 63/326,156, filed on Mar. 31, 2022.

(51) Int. Cl. G06N 3/092; G06N 3/098

(52) U.S. Cl. CPC G06N 3/092; G06N 3/098

(57) ABSTRACT

According to examples, a system for serving distributed inference deep learning (DL) models in serverless computing is described. The system may include a processor and a memory storing instructions. The processor, when executing the instructions, may cause the system to receive a request to initialize a container and request a first candidate server from an available resource finder and a second candidate server from a resource optimizer. The processor, when executing the instructions, may then implement the server allocator to prioritize use of one of the first candidate server and the second candidate server and provide feedback regarding the prioritized use of one of the first candidate server and the second candidate server.

### PRIORITY

This patent application claims priority to U.S. Provisional Patent Application No. 63/326,156, entitled “Serving Distributed Inference Deep Learning (DL) Models in Serverless Computing,” filed on Mar. 31, 2022.

### TECHNICAL FIELD

This patent application relates generally to generation and delivery of computing resources, and more specifically, to systems and methods for serving distributed inference deep learning (DL) models in serverless computing.

### BACKGROUND

In some examples, serverless computing (SC) may include cloud computing execution models that include server maintenance and allocating machine resources on demand. In serverless computing (SC), servers may be used by cloud service providers to execute code while not holding resources in volatile memory.

In some instances, serverless computing (SC) may be a “win-win” for providers and users. In particular, in some instances, serverless computing (SC) may offer greater flexibility and control over resource utilization (e.g., for cloud providers), while reducing costs and capacity management (e.g., for customers).

However, in some examples, implementation of serverless computing may also present hurdles. In some instances, while serverless computing (SC) has been shown to be effective for event-triggered web applications, implementation of deep learning (DL) applications on serverless computing (SC) may be limited.

### BRIEF DESCRIPTION OF DRAWINGS

Features of the present disclosure are illustrated by way of example and not limited in the following figures, in which like numerals indicate like elements. One skilled in the art will readily recognize from the following that alternative examples of the structures and methods illustrated in the figures can be employed without departing from the principles described herein.

FIG. 1A illustrates a diagram of an implementation structure for a neural network (NN) implementing deep learning, according to an example.

FIG. 1B illustrates a diagram of an implementation structure for serving distributed inference deep learning (DL) models in serverless computing, according to an example.

FIG. 1C illustrates a diagram of an implementation structure for serving distributed inference deep learning (DL) models in serverless computing, according to an example.

FIG. 2A illustrates a block diagram of a system environment, including a system, to serve distributed inference deep learning (DL) models in serverless computing, according to an example.

FIG. 2B illustrates a block diagram of a system to serve distributed inference deep learning (DL) models in serverless computing, according to an example.

FIG. 2C illustrates a graphical representation illustrating a similarity percentage of block chunks for multiple model files for different block sizes, according to an example.

FIG. 2D illustrates a diagram illustrating aspects of a hybrid scheduler serving distributed inference deep learning (DL) models in serverless computing, according to an example.

FIG. 3 illustrates a block diagram of a computer system to serve distributed inference deep learning (DL) models in serverless computing, according to an example.

FIG. 4 illustrates a flow diagram of a method for serving distributed inference deep learning (DL) models in serverless computing, according to an example.

### DETAILED DESCRIPTION

For simplicity and illustrative purposes, the present application is described by referring mainly to examples thereof. In the following description, numerous specific details are set forth in order to provide a thorough understanding of the present application. It will be readily apparent, however, that the present application may be practiced without limitation to these specific details. In other instances, some methods and structures readily understood by one of ordinary skill in the art have not been described in detail so as not to unnecessarily obscure the present application. As used herein, the terms “a” and “an” are intended to denote at least one of a particular element, the term “includes” means includes but not limited to, the term “including” means including but not limited to, and the term “based on” means based at least in part on.

As used herein, a “user” may include any user of a computing device or digital content delivery mechanism who receives or interacts with delivered content items, which may be visual, non-visual, or a combination thereof. Also, as used herein, “content”, “digital content”, “digital content item” and “content item” may refer to any digital data (e.g., a data file). Examples include, but are not limited to, digital images, digital video files, digital audio files, and/or streaming content. Additionally, the terms “content”, “digital content item,” “content item,” and “digital item” may refer interchangeably to themselves or to portions thereof.

In some examples, serverless computing (SC) may include cloud computing execution models that include allocating machine resources on demand and maintaining servers on behalf of users. In serverless computing (SC), servers may be used by cloud service providers to execute code for developers, while not holding resources in volatile memory. In serverless computing (SC), computing may be done in short bursts, and when an application may not be in use, there may be no computing resources allocated to the application.

In some examples, serverless computing (SC) may enable a set of functions and event triggers to execute associated functions and management of memory requirement(s). Resource utilization, and associated costs and pricing, may be dependent on how long a function may run, how many times a function may be invoked, and/or how much memory the serverless computing (SC) process may consume. As such, in some instances, serverless computing (SC) may be ideal for event triggered applications and for exploiting compute parallelism.

Accordingly, in some instances, serverless computing (SC) may be a “win-win” for providers and users. In particular, in some instances, serverless computing (SC) may offer greater flexibility and control over resource utilization for cloud providers, while reducing costs through pay-per-use cost models and eliminating capacity management for customers.

In some examples, enabling machine learning (ML) in serverless computing may be directed various aspects of computing, including inference learning and training. In some examples, learning may include deploying various machine learning (ML) models and measuring resource utilization and performance associated with serving associated inference requests. In some examples, design and implementation of a serverless framework for training may include machine learning (ML), predictive analytics, and distributed double machine learning. In addition, training may include, for example and not limited to, implementing minimizing of cold start latency and use of fast shared storage across serverless containers.

However, in some examples, implementation of serverless computing may also present hurdles. In particular, in some instances, while serverless computing (SC) may have been shown to be effective for event-triggered web applications, use of deep learning (DL) applications on serverless computing (SC) may be limited. In particular, implementation of serverless computing (SC) may be limited due to latency-sensitive deep learning (DL) applications and “stateless” serverless computing (SC). In addition, in some examples, implementation of distributed interference (DI) models on serverless computing (SC) may present multiple issues. Examples include resource allocation and “cold start” latency.

In some examples and as described herein, the systems and methods described may utilize and/or implement a neural network (NN). In some examples, a neural network (NN) that may be implemented may include one or more computing devices configured to implement one or more networked machine-learning (ML) algorithms to “learn” by progressively extracting higher-level information from input data. It should be appreciated that, in addition to or instead of a neural network (NN), other computing mechanisms may be utilized as well, such as tree-based models (e.g., boosted trees).

In some examples, the one or more networked machine-learning (ML) algorithms of a neural network (NN) may implement “deep learning”. A neural network (NN) implementing deep learning and artificial intelligence (AI) techniques may, in some examples, utilize one or more “layers” to dynamically transform input data into progressively more abstract and/or composite representations. These abstract and/or composite representations may be analyzed to determine hidden patterns and correlations and determine one or more relationships or association(s) within the input data.

The systems and methods described herein may utilize various neural network (NN) technologies. Examples of neural network (NN) mechanisms that may be employed may include an artificial neural network (ANN), a sparse neural network (SNN), a convolutional neural network (CNN), and a recurrent neural network (RNN). Additional examples of neural network mechanisms that may be employed may also include a long/short term memory (LSTM), a gated repeated unit (GRU), a Hopfield network, a Boltzmann machine, a deep belief network and a generative adversarial network (GAN).

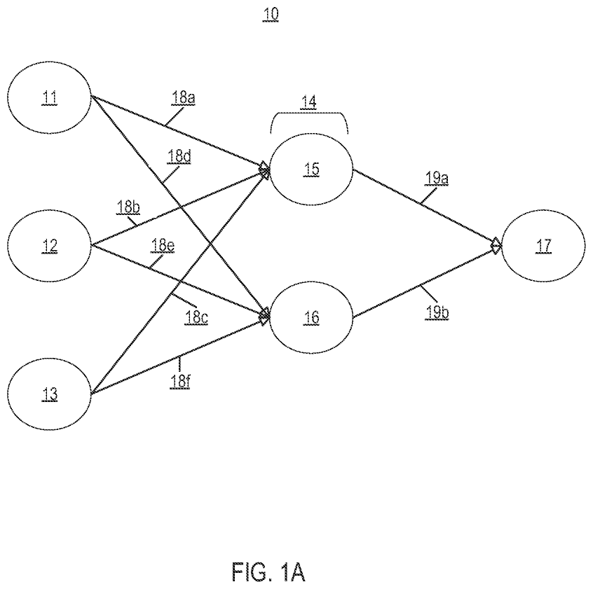

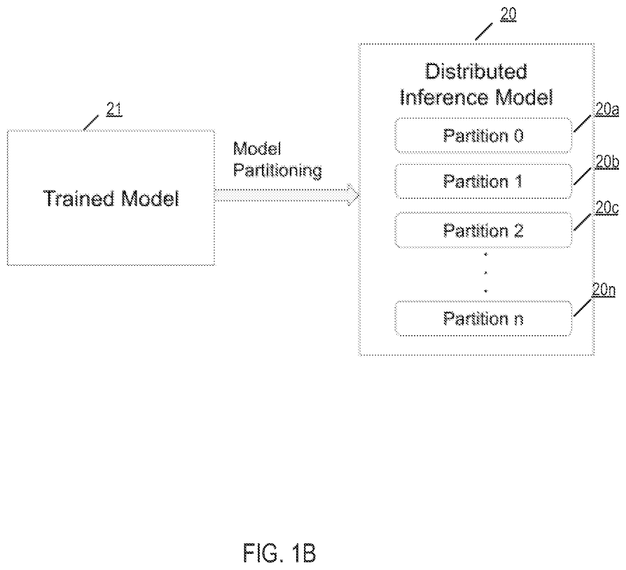

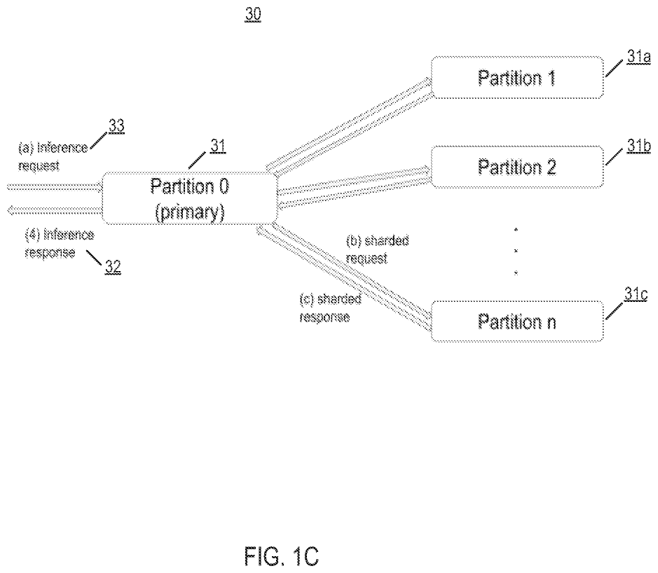

FIG. 1A illustrates a diagram of an implementation structure for a neural network (NN) implementing artificial intelligence (AI) and deep learning, according to an example. In some examples, implementation of neural network 10 (hereinafter also referred to as “network 10”) may include organizing a structure of the network 10 and “training” the network 10. Although an example of a neural network is provided here, it should be appreciated that (as discussed above) other computational methods may be utilized as well.

In some examples, organizing the structure of the network 10 may include network elements including one or more inputs, one or more nodes and an output. In some examples, a structure of the network 10 may be defined to include a plurality of inputs 11, 12, 13, a layer 14 with a plurality of nodes 15, 16, and an output 17.

In addition, in some examples, organizing the structure of the network 10 may include assigning one or more weights associated with the plurality of nodes 15, 16. In some examples, the network 10 may implement a first group of weights 18, including a first weight 18a between the input 11 and the node 15, a second weight 18b between the input 12 and the node 15, a third weight 18c between the input 13 and the node 15. In addition, the network 10 may implement a fourth weight 18d between the input 11 and the node 16, a fifth weight 18e between the input 12 and the node 16, and a sixth weight 18f between the input 13 and the node 16 as well. In addition, a second group of weights 19, including the first weight 19a between the node 15 and the output 17 and the second weight 19b between the node 16 and the output 17 may be implemented as well.

In some examples, “training” the network 10 may include utilization of one or more “training datasets” {(xᵢ, yᵢ)}, where i=1 . . . N for an N number of data pairs. In particular, as will be discussed below, the one or more training datasets {(xᵢ, yᵢ)} may be used to adjust weight values associated with the network 10.

Training of the network 10 may also include, in some examples, may also include implementation of forward propagation and backpropagation. Implementation of forward propagation and backpropagation may include enabling the network 10 to adjust aspects, such as weight values associated with nodes, by looking to past iterations and outputs. In some examples, a forward “sweep” through the network 10 to compute an output for each layer. At this point, in some examples, a difference (e.g., a “loss”) between an output of a final layer and a desired output may be “back-propagated” through previous layers by adjusting weight values associated with the nodes in order to minimize a difference between an estimated output from the network 10 (e.g., an “estimated output”) and an output the network 10 was meant to produce (e.g., a “ground truth”). In some examples, training of the network 10 may require numerous iterations, as the weights may be continually adjusted to minimize a difference between estimated output and an output the network 10 was meant to produce.

In some examples, once weights for the network 10 may be learned, the network 10 may be used make a prediction or “inference”. In some examples, the network 10 may make an inference for a data instance, x*, which may not have been included in the training datasets {(xᵢ, yᵢ)}, to provide an output value y* (e.g., an inference) associated with the data instance x*. Furthermore, in some examples, a prediction loss indicating a predictive quality (e.g., accuracy) of the network 10 may be ascertained by determining a “loss” representing a difference between the estimated output value y* and an associated ground truth value.

FIG. 1B illustrates an example of a distributed inference (DI) model 20 created from a trained model 21. In some examples, the distributed inference (DI) model 20 may include multiple partitions 20a, 20b, 20c, . . . 20n obtained from partitioning of the trained model 21. In some examples, a plurality of partitions may consist of different embeddings (and associated data). Furthermore, in some examples, a number of partitions may be dependent upon performance benchmarking.

FIG. 1C illustrates an example of a distributed inference (DI) model 30. In some examples, an inference request 0 may arrive at a primary partition 31. In some examples, the primary partition 31 may split a request across other partitions 31a, 31b, . . . 31n, and may wait for responses from the other partitions 31a, 31b, . . . 31n. Upon receiving one or more responses, the primary partition 31 may construct and return an inference response 32. In some examples, each partition may be deployed in a dedicated container, wherein to serve an inference request 33 each of the partitions may be executed. It may be appreciated that, in some instances, a partition may be intensive on memory or compute resources.

In some examples, to enable distributed inference models via serverless computing, it may be necessary to provide (one or all) model partitions with associated memory requirements. Furthermore, it may be necessary to enable one or more event triggers to process an inference request and to obtain an inference response. In some examples, each partitioned model may be executed in a memory-bound container, wherein an amount of memory may correspond to an amount of processing resources available to the memory-bound container.

With regard to implementation of distributed inference (DI) models, and in particular recurrently trained distributed inference (DI) models, computing capacity that may be provided for each serverless container may be dependent on memory and processing resources (e.g., resource allocation). In some examples, allocations (e.g., of machine resources) associated with a container may not exceed a maximum memory and processing resource allocation available. Moreover, in some examples, each serverless container may consist of a defined memory size and a processing allotment. In these instances, for a set of containers and a set of servers, allocation may be associated with a “bin-packing” problem.

In some instances, addressing the bin-packing problem may enable optimal resource utilization by effectively increasing a number of containers that may be executed. In increasing a number of containers, container allocation may be relatively instantaneous and resource allocation may be optimal. However, in some instances, overcoming the bin-packing problem may be computationally and temporally intensive. Indeed, in some instances, providing event triggered container execution in a serverless architecture and addressing bin-packing latency may not be feasible.

In some examples, accuracy and performance of a machine learning (ML) model may be enhanced by increasing a training dataset. As data may continuously be incoming, new data may combine with old data to generate larger and larger datasets. In some instances, this data may be utilized to retrain associated models (e.g., online or offline). That is, in some instances, this data may be utilized to update (e.g., adjust) weights without implementing any major changes to a feature space on which a model may be built. In some examples, a retrained model may be deployed periodically, and may be implemented in association with a new container. That is, in some examples and depending on traffic pattern(s) of one or more requests, both a new version and old version executing at a same time may serve different requests. Furthermore, assuming incoming requests may be uniformly distributed (e.g., one hundred (100) requests per second) with a typical period for inference serving latency (e.g., where time to download, start up, and serve a container may be ten (10) seconds), both an old model and new model may serve one thousand (1000) requests within a ten (10) second window (e.g., immediately after new model version may be deployed).

In some examples, although versions of one or more old models may be subject to warm starts (thereby reducing serving latency), it may be the case that one or more new model versions may incur “cold-start” latency. Furthermore, in some instances, this latency may be exacerbated for distributed inference (DI) models of larger partition sizes (e.g., ten (10) gigabytes or more). In some examples, this difference in cold start and warm start latencies may create unpredictable performance of serving requests.

Systems and methods described herein may provide implementation of distributed inference (DI) models on serverless computing (SC). In some examples, the systems and methods may implement a hybrid scheduler to identify an optimal server resource allocation policy, and may further identify container allocation based on candidate allocations and deep reinforcement learning based allocation models. In some examples, the systems and methods may provide a deep reinforcement learning based hybrid scheduler that may maximize performance and increase resource utilization for a cloud provider.

In some instances, an abundance of existing data (e.g., user data) may have led to a need for improved data generation and analysis. To enable this data generation and analysis, various deep learning (DL) models and techniques may be utilized. However, implementation of these deep learning (DL) models and techniques may require high-performance computing resources, and in particular may require enhanced server capacity (e.g., enhanced processing power and memory).

In instances where the server capacity may be limited, distributed inference (DI) models may be implemented. In some examples, distributed inference (DI) models may be implemented in instances were an inference model may not “fit” into one physical machine. In these instances, the distributed inference (DI) (e.g., learning) model may require configuring, deploying, and managing of resource allocation, where performance of the distributed interference (DI) model may be fine-tuned based on existing deployments. Moreover, in these instances, performance of the distributed interference (DI) model may be optimized to improve capacity utilization and minimize monetary costs associated with implementing the model on a cloud.

In some examples, the systems and methods described may include a system comprising a processor and a memory storing instructions, which when executed by the processor, cause the processor to receive a request to initialize a container, receive a first candidate server from an available resource finder and a second candidate server from a resource optimizer, implement a server allocator to prioritize use of one of the first candidate server and the second candidate server, and receive feedback regarding the prioritized use of one of the first candidate server and the second candidate server. In some examples, the resource optimizer may include a deep reinforcement learning model, and the first candidate server and the second candidate server may be the same. In some examples, a request to receive the first candidate server from the available resource finder and a request to receive the second candidate server from the resource optimizer may be transmitted in parallel. In some examples, the instructions, which when executed by the processor, cause the processor to prioritize the second candidate server if it may be valid. In some examples, the instructions, which when executed by the processor, may cause the processor to implement a hybrid scheduler to address a time-dependency tradeoff, the hybrid scheduler including the server allocator, the resource optimizer, and the available resource finder. In some examples, the instructions, which when executed by the processor, may cause the processor to evaluate a similarity across two versions of recurrently trained distributed inference models.

In some examples, the systems and methods described may include a method of serving distributed inference deep learning (DL) models in serverless computing, comprising receiving a request to initialize a container, receiving a first candidate server from an available resource finder and a second candidate server from a resource optimizer, implementing a server allocator to prioritize use of one of the first candidate server and the second candidate server, and receive feedback regarding the prioritized use of one of the first candidate server and the second candidate server.

In some examples, a non-transitory computer-readable storage medium having an executable stored thereon, which when executed instructs a processor to receive a request to initialize a container, receive a first candidate server from an available resource finder and a second candidate server from a resource optimizer, implement a server allocator to prioritize use of one of the first candidate server and the second candidate server, and receive feedback regarding the prioritized use of one of the first candidate server and the second candidate server.

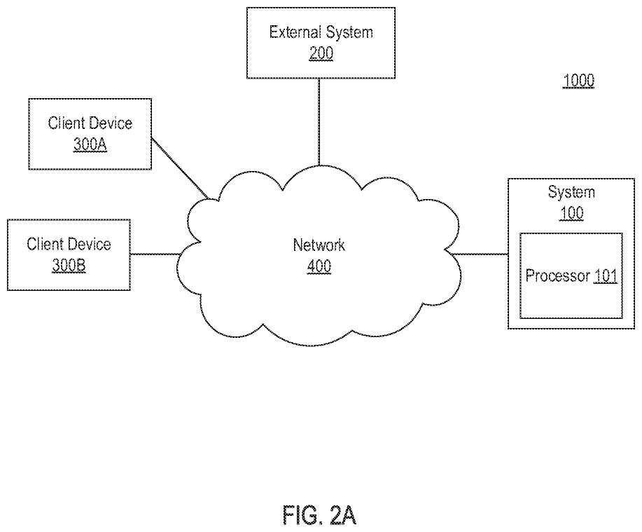

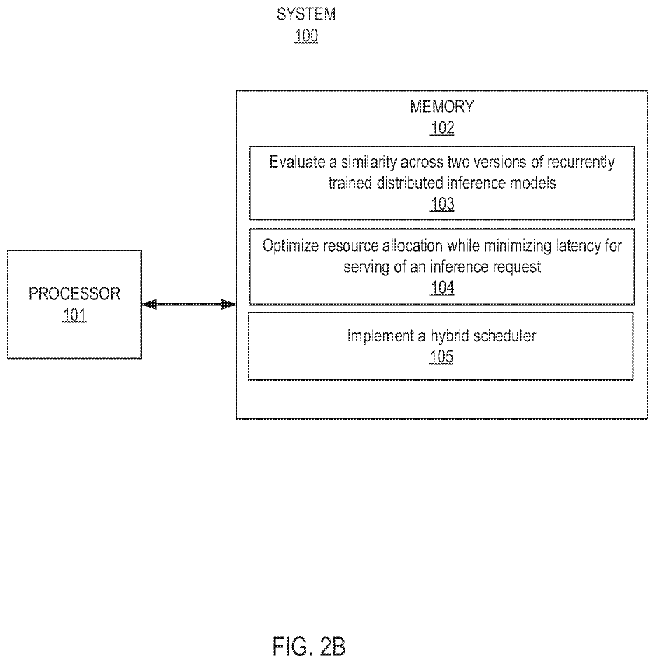

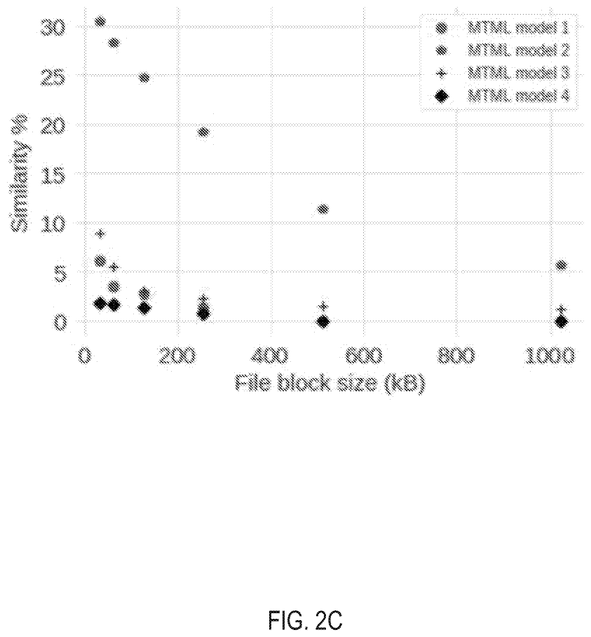

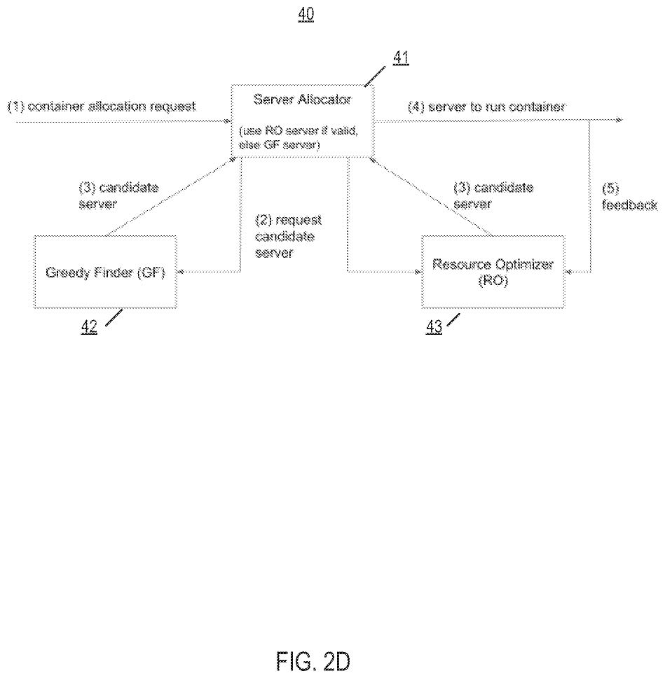

Reference is now made to FIGS. 2A-C. FIG. 2A illustrates a block diagram of a system environment, including a system, to serve distributed inference deep learning (DL) models in serverless computing, according to an example. FIG. 2B illustrates a block diagram of a system, to serve distributed inference deep learning (DL) models in serverless computing, according to an example.

As will be described in the examples below, one or more of system 100, external system 200, user devices 300A-300B and system environment 1000 shown in FIGS. 2A-2B may be operated by a service provider to serve distributed inference deep learning (DL) models in serverless computing. It should be appreciated that one or more of the system 100, the external system 200, the user devices 300A-300B and the system environment 1000 depicted in FIGS. 2A-2B may be provided as examples. Thus, one or more of the system 100, the external system 200 the user devices 300A-300B and the system environment 1000 may or may not include additional features and some of the features described herein may be removed and/or modified without departing from the scopes of the system 100, the external system 200, the user devices 300A-300B and the system environment 1000 outlined herein. Moreover, in some examples, the system 100, the external system 200, and/or the user devices 300A-300B may be or associated with a social networking system, a content sharing network, an advertisement system, an online system, and/or any other system that facilitates any variety of digital content in personal, social, commercial, financial, and/or enterprise environments.

While the servers, systems, subsystems, and/or other computing devices shown in FIGS. 2A-2B may be shown as single components or elements, it should be appreciated that one of ordinary skill in the art would recognize that these single components or elements may represent multiple components or elements, and that these components or elements may be connected via one or more networks. Also, middleware (not shown) may be included with any of the elements or components described herein. The middleware may include software hosted by one or more servers. Furthermore, it should be appreciated that some of the middleware or servers may or may not be needed to achieve functionality. Other types of servers, middleware, systems, platforms, and applications not shown may also be provided at the front-end or back-end to facilitate the features and functionalities of the system 100, the external system 200, the user devices 300A-300B or the system environment 1000.

It should also be appreciated that the systems and methods described herein may be particularly suited for digital content, but are also applicable to a host of other distributed content or media. These may include, for example, content or media associated with data management platforms, search or recommendation engines, social media, and/or data communications involving communication of various information (e.g., transaction information). These and other benefits will be apparent in the descriptions provided herein.

In some examples, the external system 200 may include any number of servers, hosts, systems, and/or databases that store data to be accessed by the system 100, the user devices 300A-300B, and/or other network elements (not shown) in the system environment 1000. In addition, in some examples, the servers, hosts, systems, and/or databases of the external system 200 may include one or more storage mediums storing any data. In some examples, and as will be discussed further below, the external system 200 may be utilized to store any information that may relate to (among other things) activity (e.g., user activity) associated with services offered by a service provider that may be operating the external system 200. As will be discussed further below, in other examples, the external system 200 may be utilized by a service provider (e.g., a social media application provider) as part of a data storage, wherein a service provider may access data on the external system 200 to serve distributed inference deep learning (DL) models in serverless computing.

In some examples, and as will be described in further detail below, the user devices 300A-300B may be utilized to, among other things, utilize artificial intelligence (AI) techniques to serve distributed inference deep learning (DL) models in serverless computing. In some examples, the user devices 300A-300B may be electronic or computing devices configured to transmit and/or receive data.

In this regard, each of the user devices 300A-300B may be any device having computer functionality, such as a television, a radio, a smartphone, a tablet, a laptop, a watch, a desktop, a server, or other computing or entertainment device or appliance. In some examples, the user devices 300A-300B may be mobile devices that are communicatively coupled to the network 400 and enabled to interact with various network elements over the network 400. In some examples, the user devices 300A-300B may execute an application allowing a user of the user devices 300A-300B to interact with various network elements on the network 400. Additionally, the user devices 300A-300B may execute a browser or application to enable interaction between the user devices 300A-300B and the system 100 via the network 400. Moreover, in some examples and as will also be discussed further below, the user devices 300A-300B may be utilized by a user viewing content (e.g., advertisements) distributed by a service provider, wherein information may be stored and transmitted by the user devices 300A to other devices, such as the external system 200.

The system environment 1000 may also include the network 400. In operation, one or more of the system 100, the external system 200 and the user devices 300A-300B may communicate with one or more of the other devices via the network 400. The network 400 may be a local area network (LAN), a wide area network (WAN), the Internet, a cellular network, a cable network, a satellite network, or other network that facilitates communication between, the system 100, the external system 200, the user devices 300A-300B and/or any other system, component, or device connected to the network 400.

The network 400 may further include one, or any number, of the exemplary types of networks mentioned above operating as a stand-alone network or in cooperation with each other. For example, the network 400 may utilize one or more protocols of one or more clients or servers to which they are communicatively coupled. The network 400 may facilitate transmission of data according to a transmission protocol of any of the devices and/or systems in the network 400. Although the network 400 is depicted as a single network in the system environment 1000 of FIG. 2A, it should be appreciated that, in some examples, the network 400 may include a plurality of interconnected networks as well.

In some examples, and as will be discussed further below, the system 100 may be configured to serve distributed inference deep learning (DL) models in serverless computing. Details of the system 100 and its operation within the system environment 1000 will be described in more detail below.

As shown in FIGS. 2A-2B, the system 100 may include processor 101 and the memory 102. In some examples, the processor 101 may be configured to execute the machine-readable instructions stored in the memory 102. It should be appreciated that the processor 101 may be a semiconductor-based microprocessor, a central processing unit (CPU), an application specific integrated circuit (ASIC), a field-programmable gate array (FPGA), and/or other suitable hardware device.

In some examples, the memory 102 may have stored thereon machine-readable instructions (which may also be termed computer-readable instructions) that the processor 101 may execute. The memory 102 may be an electronic, magnetic, optical, or other physical storage device that contains or stores executable instructions. The memory 102 may be, for example, random access memory (RAM), an Electrically Erasable Programmable Read-Only Memory (EEPROM), a storage device, an optical disc, or the like. The memory 102, which may also be referred to as a computer-readable storage medium, may be a non-transitory machine-readable storage medium, where the term “non-transitory” does not encompass transitory propagating signals. It should be appreciated that the memory 102 depicted in FIGS. 2A-2B may be provided as an example. Thus, the memory 102 may or may not include additional features, and some of the features described herein may be removed and/or modified without departing from the scope of the memory 102 outlined herein.

It should be appreciated that, and as described further below, the processing performed via the instructions on the memory 102 may or may not be performed, in part or in total, with the aid of other information and data, such as information and data provided by the external system 200 and/or the user devices 300A-300B. Moreover, and as described further below, it should be appreciated that the processing performed via the instructions on the memory 102 may or may not be performed, in part or in total, with the aid of or in addition to processing provided by other devices, including for example, the external system 200 and/or the user devices 300A-300B.

In some examples, the memory 102 may store instructions, which when executed by the processor 101, may cause the processor to: evaluate a similarity across two versions of recurrently trained distributed inference models; optimize resource allocation while minimizing latency for serving of an inference request; and implement a hybrid scheduler. In some examples, the instructions 103-105 may be utilized to ensure that performance may not compromised and that resource allocation may be optimized.

In some examples, and as discussed further below, the instructions 103-105 on the memory 102 may be executed alone or in combination by the processor 101 to serve distributed inference deep learning (DL) models in serverless computing. In some examples, the instructions 103-105 may be implemented in association with a content platform to provide content for users, while in other examples, the instructions 103-105 may be implemented as part of a stand-alone application.

Additionally, and as described above, although not depicted, it should be appreciated that to serve distributed inference deep learning (DL) models in serverless computing, instructions 103-105 may utilize various artificial intelligence (AI) and machine learning (ML) based tools. For instance, these artificial intelligence (AI) and machine learning (ML) based tools may be used to generate models that may include a neural network (e.g., a recurrent neural network (RNN)), generative adversarial network (GAN), a tree-based model, a Bayesian network, a support vector, clustering, a kernel method, a spline, a knowledge graph, or an ensemble of one or more of these and other techniques. It should also be appreciated that the system 100 may provide other types of machine learning (ML) approaches as well, such as reinforcement learning, feature learning, anomaly detection, etc.

In some examples, content similarity may be exploited to reduce container start up times. Since, in some examples, a retrained model may include updates to associated weights without including major changes in an associated feature space, the instructions 103 may be implemented to evaluate a similarity (e.g., a degree of similarity) across two versions of recurrently trained distributed inference models. In some examples, to evaluate the similarity across two versions, the instructions 103 may implement a deep learning (DL), multi-task multi-label (MTML) model.

In some examples, the instructions 103 may compute similarity in utilizing one or more versions of a recurrently trained model. It may be appreciated that similarities in files (e.g., models) may negate a need for redundant processing by one or more processing resources. In addition, in some examples, the instructions 103 may divide each version of the recurrently trained model into file blocks (or “chunks”) of size ranging from thirty-two (32) kilobytes (kB) to one thousand twenty-four (1024) kilobytes (kB).

FIG. 2C illustrates a graphical representation illustrating a similarity percentage of block chunks for multiple model files for different block sizes, according to an example. It may be appreciated that, in some examples, dividing one or more models into smaller block sizes may result to higher similarity (e.g., producing a similarity increase of up to 33%). It may further be appreciated that deploying a models with higher similarity on a same server may minimize a number of file blocks to be downloaded on the (same) server, thereby reducing container start up latency.

In some examples, to implement a distributed inference (DI) model in a serverless computing (SC), the instructions 104 may optimize resource allocation while minimizing latency for serving of an inference request. It may be appreciated that resource allocation may be a time-intensive process that may require periodic evaluation of network topology, switch bandwidth, over-subscription ratio, and multiple server parameters (e.g., utilization, size and number of processing elements and memory units, network bandwidth, etc.).

However, it may also be appreciated that, in some instances, increasing adoption of additional (e.g., novel) hardware using application specific integrated circuits (ASICs) and graphics processing unit (GPU) makes evaluations between server parameters difficult. It may further be appreciated that minimizing latency for serving an inference request may time-critical, since it may require evaluation of content similarity (e.g., as provided via the instructions 103) and existing container placements may directly impact container start up latency.

Accordingly, in some examples, the instructions 105 may implement a hybrid scheduler. In some examples, the hybrid scheduler implemented via the instructions 105 may be configured to address a time-dependency tradeoff as discussed above. FIG. 2D illustrates a diagram illustrating aspects of a hybrid scheduler serving distributed inference deep learning (DL) models in serverless computing, according to an example. In some examples, the hybrid scheduler 40 implemented via the instructions 105 may include a plurality of components. In some examples, a first component may be a server allocator 41, a second component may be a resource optimizer 42, and a third component may be an available resource finder 43. As used herein, an “available resource finder” may, among other things, determine and provide a first resource that may be utilized to serve a request. In some examples, the available resource finder 43 may determine a first available resource (e.g., based on associated availability, requirements, and criteria). In some instances, the available resource finder may also be referred to as a “greedy” finder.

In some examples, the instructions 105 may implement the hybrid scheduler according to one or more processing flows. In some examples, initially, the instructions 105 may receive a request to initialize (e.g., start up or “boot up”) a container (e.g., a “container request”).

Upon receiving the request to initialize, the instructions 105 may implement a server allocator (e.g., the server allocator 41), an available resource finder (e.g., the available resource finder 43), and a resource optimizer (e.g., the resource optimizer 42). In some examples, the instructions 105 may implement the server allocator to receive (e.g., upon providing a request) a candidate server from the greedy finder and the resource optimizer. In some examples, the instructions 105 may provide a request to receive the candidate server from the available resource finder and a request to receive the candidate server from the resource optimizer in parallel.

Upon completing the request for the candidate server, the instructions 105 may utilize a resource optimizer to implement a deep reinforcement learning model. Furthermore, in some examples, the instructions 105 may receive a server allocation request and may provide a candidate server as well.

In some examples, the deep reinforcement learning model may be recurrently trained over time, and may continuously “learn” optimized allocation of resource requests utilizing generated feedback (e.g., “reinforcement learning”). Examples of the feedback may include determinations related to efficiency, usage, and allocation consequences of implementing a candidate server received from the resource optimizer.

In addition, in some examples, the instructions 105 may utilize an available resource finder to provide a candidate server. In some examples, the available resource finder may identify a first server that may be able to accommodate the requested container.

In some examples, upon receiving the candidate server, the instructions 105 may implement a server allocator to prioritize use of the resource allocator's candidate server, if it is valid (e.g., it has capacity to initialize the requested container). However, in an instance where the instructions 105 may determine that the resource allocator's candidate server may not be valid, the instructions 105 may utilize the available resource finder's candidate server. In some examples, the instructions 105 may implement the resource allocator as a presumptive default, and may implement associated criteria based on processing and memory resources to determine whether to prioritize use of the resource allocator's candidate server or the available resource finder's candidate server.

In some examples, the instructions 105 may implement a server allocator to provide feedback regarding a candidate server that was used and may receive the feedback from the server allocator. For example, in some instances, the instructions 105 may provide feedback to a resource optimizer if the candidate server proposed by the resource optimizer was used for container placement.

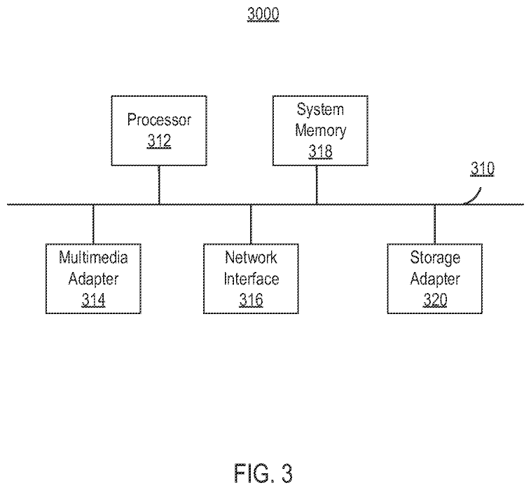

FIG. 3 illustrates a block diagram of a computer system for serving distributed inference deep learning (DL) models in serverless computing, according to an example. In some examples, the system 3000 may be associated the system 100 to perform the functions and features described herein. The system 3000 may include, among other things, an interconnect 310, a processor 312, a multimedia adapter 314, a network interface 316, a system memory 318, and a storage adapter 320.

The interconnect 310 may interconnect various subsystems, elements, and/or components of the external system 300. As shown, the interconnect 310 may be an abstraction that may represent any one or more separate physical buses, point-to-point connections, or both, connected by appropriate bridges, adapters, or controllers. In some examples, the interconnect 310 may include a system bus, a peripheral component interconnect (PCI) bus or PCI-Express bus, a HyperTransport or industry standard architecture (ISA)) bus, a small computer system interface (SCSI) bus, a universal serial bus (USB), IIC (12C) bus, or an Institute of Electrical and Electronics Engineers (IEEE) standard 1394 bus, or “firewire,” or other similar interconnection element.

In some examples, the interconnect 310 may allow data communication between the processor 312 and system memory 318, which may include read-only memory (ROM) or flash memory (neither shown), and random access memory (RAM) (not shown). It should be appreciated that the RAM may be the main memory into which an operating system and various application programs may be loaded. The ROM or flash memory may contain, among other code, the Basic Input-Output system (BIOS) which controls basic hardware operation such as the interaction with one or more peripheral components.

The processor 312 may be the central processing unit (CPU) of the computing device and may control overall operation of the computing device. In some examples, the processor 312 may accomplish this by executing software or firmware stored in system memory 318 or other data via the storage adapter 320. The processor 312 may be, or may include, one or more programmable general-purpose or special-purpose microprocessors, digital signal processors (DSPs), programmable controllers, application specific integrated circuits (ASICs), programmable logic device (PLDs), trust platform modules (TPMs), field-programmable gate arrays (FPGAs), other processing circuits, or a combination of these and other devices.

The multimedia adapter 314 may connect to various multimedia elements or peripherals. These may include devices associated with visual (e.g., video card or display), audio (e.g., sound card or speakers), and/or various input/output interfaces (e.g., mouse, keyboard, touchscreen).

The network interface 316 may provide the computing device with an ability to communicate with a variety of remote devices over a network (e.g., network 400 of FIG. 2A) and may include, for example, an Ethernet adapter, a Fibre Channel adapter, and/or other wired- or wireless-enabled adapter. The network interface 316 may provide a direct or indirect connection from one network element to another, and facilitate communication and between various network elements.

The storage adapter 320 may connect to a standard computer-readable medium for storage and/or retrieval of information, such as a fixed disk drive (internal or external).

Many other devices, components, elements, or subsystems (not shown) may be connected in a similar manner to the interconnect 310 or via a network (e.g., network 400 of FIG. 2A). Conversely, all of the devices shown in FIG. 3 need not be present to practice the present disclosure. The devices and subsystems can be interconnected in different ways from that shown in FIG. 3. Code to implement the dynamic approaches for payment gateway selection and payment transaction processing of the present disclosure may be stored in computer-readable storage media such as one or more of system memory 318 or other storage. Code to implement the dynamic approaches for payment gateway selection and payment transaction processing of the present disclosure may also be received via one or more interfaces and stored in memory. The operating system provided on system 100 may be MS-DOS, MS-WINDOWS, OS/2, OS X, IOS, ANDROID, UNIX, Linux, or another operating system.

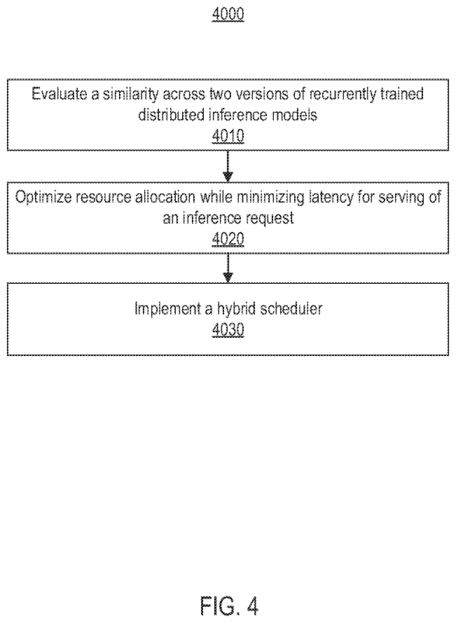

FIG. 4 illustrates a flow diagram of a method for serving distributed inference deep learning (DL) models in serverless computing, according to an example. The method 4000 is provided by way of example, as there may be a variety of ways to carry out the method described herein. Each block shown in FIG. 4 may further represent one or more processes, methods, or subroutines, and one or more of the blocks may include machine-readable instructions stored on a non-transitory computer-readable medium and executed by a processor or other type of processing circuit to perform one or more operations described herein.

Although the method 4000 is primarily described as being performed by system 100 as shown in FIGS. 2A-2B, the method 4000 may be executed or otherwise performed by other systems, or a combination of systems. It should be appreciated that, in some examples, to serve distributed inference deep learning (DL) models in serverless computing, the method 4000 may be configured to incorporate artificial intelligence (AI) or deep learning techniques, as described above. It should also be appreciated that, in some examples, the method 4000 may be implemented in conjunction with a content platform (e.g., a social media platform) to generate and deliver content.

Reference is now made with respect to FIG. 4. At 4010, the processor 101 may evaluate a similarity across two versions of recurrently trained distributed inference models. In some examples, to evaluate the similar across two versions, the instructions 103 may implement a deep learning (DL), multi-task multi-label (MTML) model.

At 4020, the processor 101 may optimize resource allocation while minimizing latency for serving of an inference request. It may be appreciated that resource allocation may be a time-intensive process that may require periodic evaluation of network topology, switch bandwidth, over-subscription ratio, and multiple server parameters (e.g., utilization, size and number of processing elements and memory units, network bandwidth, etc.).

At 4030, the processor 101 may implement a hybrid scheduler. In some examples, the hybrid scheduler implemented via the processor 101 may include (among other things) a server allocator, a resource optimizer, and an available resource finder. Upon receiving the request to initialize, the processor 101 may implement a server allocator, an available resource finder, and a resource optimizer. In some examples, the processor 101 may implement the server allocator to request a candidate server from the available resource finder and the resource optimizer. In some examples, the request from the available resource finder and the resource optimizer may be conducted in parallel.

In some examples, the processor 101 may utilize a resource optimizer to implement a deep reinforcement learning model. In some examples, the deep reinforcement learning model may be recurrently trained over time. Furthermore, in some examples, the processor 101 may receive a server allocation request and may provide a candidate server as well.

In some examples, the processor 101 may utilize an available resource finder to provide a candidate server. In some examples, the available resource finder may identify a first server that may be able to accommodate the requested container.

In some examples, upon receiving both the candidate server, the processor 101 may implement the server allocator to prioritize use of the resource allocator's candidate server if it is valid (e.g., it has capacity to initialize the requested container). However, in an instance where the processor 101 may determine that the resource allocators candidate server may not be valid, the processor 101 may utilize the available resource finder's candidate server.

In some examples, the processor 101 may implement the server allocator to provide feedback regarding a candidate server that was used. For example, in some instances, the processor 101 may provide feedback to a resource optimizer if the candidate server proposed by the resource optimizer was used for container placement.

Although the methods and systems as described herein may be directed mainly to digital content, such as videos or interactive media, it should be appreciated that the methods and systems as described herein may be used for other types of content or scenarios as well. Other applications or uses of the methods and systems as described herein may also include social networking, marketing, content-based recommendation engines, and/or other types of knowledge or data-driven systems.

It should be noted that the functionality described herein may be subject to one or more privacy policies, described below, enforced by the system 100, the external system 200, and the user devices 300A-300B that may bar use of images for concept detection, recommendation, generation, and analysis.

In particular examples, one or more objects of a computing system may be associated with one or more privacy settings. The one or more objects may be stored on or otherwise associated with any suitable computing system or application, such as, for example, the system 100, the external system 200, and the user devices 300, a social-networking application, a messaging application, a photo-sharing application, or any other suitable computing system or application. Although the examples discussed herein may be in the context of an online social network, these privacy settings may be applied to any other suitable computing system. Privacy settings (or “access settings”) for an object may be stored in any suitable manner, such as, for example, in association with the object, in an index on an authorization server, in another suitable manner, or any suitable combination thereof. A privacy setting for an object may specify how the object (or particular information associated with the object) can be accessed, stored, or otherwise used (e.g., viewed, shared, modified, copied, executed, surfaced, or identified) within the online social network. When privacy settings for an object allow a particular user or other entity to access that object, the object may be described as being “visible” with respect to that user or other entity. As an example and not by way of limitation, a user of the online social network may specify privacy settings for a user-profile page that identify a set of users that may access work-experience information on the user-profile page, thus excluding other users from accessing that information.

In particular examples, privacy settings for an object may specify a “blocked list” of users or other entities that should not be allowed to access certain information associated with the object. In particular examples, the blocked list may include third-party entities. The blocked list may specify one or more users or entities for which an object is not visible. As an example and not by way of limitation, a user may specify a set of users who may not access photo albums associated with the user, thus excluding those users from accessing the photo albums (while also possibly allowing certain users not within the specified set of users to access the photo albums). In particular examples, privacy settings may be associated with particular social-graph elements. Privacy settings of a social-graph element, such as a node or an edge, may specify how the social-graph element, information associated with the social-graph element, or objects associated with the social-graph element can be accessed using the online social network. As an example and not by way of limitation, a particular concept node corresponding to a particular photo may have a privacy setting specifying that the photo may be accessed only by users tagged in the photo and friends of the users tagged in the photo. In particular examples, privacy settings may allow users to opt in to or opt out of having their content, information, or actions stored/logged by the system 100, the external system 200, and the user devices 300, or shared with other systems. Although this disclosure describes using particular privacy settings in a particular manner, this disclosure contemplates using any suitable privacy settings in any suitable manner.

In particular examples, the system 100, the external system 200, and the user devices 300A-300B may present a “privacy wizard” (e.g., within a webpage, a module, one or more dialog boxes, or any other suitable interface) to the first user to assist the first user in specifying one or more privacy settings. The privacy wizard may display instructions, suitable privacy-related information, current privacy settings, one or more input fields for accepting one or more inputs from the first user specifying a change or confirmation of privacy settings, or any suitable combination thereof. In particular examples, the system 100, the external system 200, and the user devices 300A-300B may offer a “dashboard” functionality to the first user that may display, to the first user, current privacy settings of the first user. The dashboard functionality may be displayed to the first user at any appropriate time (e.g., following an input from the first user summoning the dashboard functionality, following the occurrence of a particular event or trigger action). The dashboard functionality may allow the first user to modify one or more of the first user's current privacy settings at any time, in any suitable manner (e.g., redirecting the first user to the privacy wizard).

Privacy settings associated with an object may specify any suitable granularity of permitted access or denial of access. As an example and not by way of limitation, access or denial of access may be specified for particular users (e.g., only me, my roommates, my boss), users within a particular degree-of-separation (e.g., friends, friends-of-friends), user groups (e.g., the gaming club, my family), user networks (e.g., employees of particular employers, students or alumni of particular university), all users (“public”), no users (“private”), users of third-party systems, particular applications (e.g., third-party applications, external websites), other suitable entities, or any suitable combination thereof. Although this disclosure describes particular granularities of permitted access or denial of access, this disclosure contemplates any suitable granularities of permitted access or denial of access.

In particular examples, different objects of the same type associated with a user may have different privacy settings. Different types of objects associated with a user may have different types of privacy settings. As an example and not by way of limitation, a first user may specify that the first user's status updates are public, but any images shared by the first user are visible only to the first user's friends on the online social network. As another example and not by way of limitation, a user may specify different privacy settings for different types of entities, such as individual users, friends-of-friends, followers, user groups, or corporate entities. As another example and not by way of limitation, a first user may specify a group of users that may view videos posted by the first user, while keeping the videos from being visible to the first user's employer. In particular examples, different privacy settings may be provided for different user groups or user demographics.

In particular examples, the system 100, the external system 200, and the user devices 300A-300B may provide one or more default privacy settings for each object of a particular object-type. A privacy setting for an object that is set to a default may be changed by a user associated with that object. As an example and not by way of limitation, all images posted by a first user may have a default privacy setting of being visible only to friends of the first user and, for a particular image, the first user may change the privacy setting for the image to be visible to friends and friends-of-friends.

In particular examples, privacy settings may allow a first user to specify (e.g., by opting out, by not opting in) whether the system 100, the external system 200, and the user devices 300A-300B may receive, collect, log, or store particular objects or information associated with the user for any purpose. In particular examples, privacy settings may allow the first user to specify whether particular applications or processes may access, store, or use particular objects or information associated with the user. The privacy settings may allow the first user to opt in or opt out of having objects or information accessed, stored, or used by specific applications or processes. The system 100, the external system 200, and the user devices 300A-300B may access such information in order to provide a particular function or service to the first user, without the system 100, the external system 200, and the user devices 300A-300B having access to that information for any other purposes. Before accessing, storing, or using such objects or information, the system 100, the external system 200, and the user devices 300A-300B may prompt the user to provide privacy settings specifying which applications or processes, if any, may access, store, or use the object or information prior to allowing any such action. As an example and not by way of limitation, a first user may transmit a message to a second user via an application related to the online social network (e.g., a messaging app), and may specify privacy settings that such messages should not be stored by the system 100, the external system 200, and the user devices 300.

In particular examples, a user may specify whether particular types of objects or information associated with the first user may be accessed, stored, or used by the system 100, the external system 200, and the user devices 300. As an example and not by way of limitation, the first user may specify that images sent by the first user through the system 100, the external system 200, and the user devices 300A-300B may not be stored by the system 100, the external system 200, and the user devices 300. As another example and not by way of limitation, a first user may specify that messages sent from the first user to a particular second user may not be stored by the system 100, the external system 200, and the user devices 300. As yet another example and not by way of limitation, a first user may specify that all objects sent via a particular application may be saved by the system 100, the external system 200, and the user devices 300.

In particular examples, privacy settings may allow a first user to specify whether particular objects or information associated with the first user may be accessed from the system 100, the external system 200, and the user devices 300. The privacy settings may allow the first user to opt in or opt out of having objects or information accessed from a particular device (e.g., the phone book on a user's smart phone), from a particular application (e.g., a messaging app), or from a particular system (e.g., an email server). The system 100, the external system 200, and the user devices 300A-300B may provide default privacy settings with respect to each device, system, or application, and/or the first user may be prompted to specify a particular privacy setting for each context. As an example and not by way of limitation, the first user may utilize a location-services feature of the system 100, the external system 200, and the user devices 300A-300B to provide recommendations for restaurants or other places in proximity to the user. The first user's default privacy settings may specify that the system 100, the external system 200, and the user devices 300A-300B may use location information provided from one of the user devices 300A-300B of the first user to provide the location-based services, but that the system 100, the external system 200, and the user devices 300A-300B may not store the location information of the first user or provide it to any external system. The first user may then update the privacy settings to allow location information to be used by a third-party image-sharing application in order to geo-tag photos.

In particular examples, privacy settings may allow a user to specify whether current, past, or projected mood, emotion, or sentiment information associated with the user may be determined, and whether particular applications or processes may access, store, or use such information. The privacy settings may allow users to opt in or opt out of having mood, emotion, or sentiment information accessed, stored, or used by specific applications or processes. The system 100, the external system 200, and the user devices 300A-300B may predict or determine a mood, emotion, or sentiment associated with a user based on, for example, inputs provided by the user and interactions with particular objects, such as pages or content viewed by the user, posts or other content uploaded by the user, and interactions with other content of the online social network. In particular examples, the system 100, the external system 200, and the user devices 300A-300B may use a user's previous activities and calculated moods, emotions, or sentiments to determine a present mood, emotion, or sentiment. A user who wishes to enable this functionality may indicate in their privacy settings that they opt in to the system 100, the external system 200, and the user devices 300A-300B receiving the inputs necessary to determine the mood, emotion, or sentiment. As an example and not by way of limitation, the system 100, the external system 200, and the user devices 300A-300B may determine that a default privacy setting is to not receive any information necessary for determining mood, emotion, or sentiment until there is an express indication from a user that the system 100, the external system 200, and the user devices 300A-300B may do so. By contrast, if a user does not opt in to the system 100, the external system 200, and the user devices 300A-300B receiving these inputs (or affirmatively opts out of the system 100, the external system 200, and the user devices 300A-300B receiving these inputs), the system 100, the external system 200, and the user devices 300A-300B may be prevented from receiving, collecting, logging, or storing these inputs or any information associated with these inputs. In particular examples, the system 100, the external system 200, and the user devices 300A-300B may use the predicted mood, emotion, or sentiment to provide recommendations or advertisements to the user. In particular examples, if a user desires to make use of this function for specific purposes or applications, additional privacy settings may be specified by the user to opt in to using the mood, emotion, or sentiment information for the specific purposes or applications. As an example and not by way of limitation, the system 100, the external system 200, and the user devices 300A-300B may use the user's mood, emotion, or sentiment to provide newsfeed items, pages, friends, or advertisements to a user. The user may specify in their privacy settings that the system 100, the external system 200, and the user devices 300A-300B may determine the user's mood, emotion, or sentiment. The user may then be asked to provide additional privacy settings to indicate the purposes for which the user's mood, emotion, or sentiment may be used. The user may indicate that the system 100, the external system 200, and the user devices 300A-300B may use his or her mood, emotion, or sentiment to provide newsfeed content and recommend pages, but not for recommending friends or advertisements. The system 100, the external system 200, and the user devices 300A-300B may then only provide newsfeed content or pages based on user mood, emotion, or sentiment, and may not use that information for any other purpose, even if not expressly prohibited by the privacy settings.

In particular examples, privacy settings may allow a user to engage in the ephemeral sharing of objects on the online social network. Ephemeral sharing refers to the sharing of objects (e.g., posts, photos) or information for a finite period of time. Access or denial of access to the objects or information may be specified by time or date. As an example and not by way of limitation, a user may specify that a particular image uploaded by the user is visible to the user's friends for the next week, after which time the image may no longer be accessible to other users. As another example and not by way of limitation, a company may post content related to a product release ahead of the official launch, and specify that the content may not be visible to other users until after the product launch.

In particular examples, for particular objects or information having privacy settings specifying that they are ephemeral, the system 100, the external system 200, and the user devices 300A-300B may be restricted in its access, storage, or use of the objects or information. The system 100, the external system 200, and the user devices 300A-300B may temporarily access, store, or use these particular objects or information in order to facilitate particular actions of a user associated with the objects or information, and may subsequently delete the objects or information, as specified by the respective privacy settings. As an example and not by way of limitation, a first user may transmit a message to a second user, and the system 100, the external system 200, and the user devices 300A-300B may temporarily store the message in a content data store until the second user has viewed or downloaded the message, at which point the system 100, the external system 200, and the user devices 300A-300B may delete the message from the data store. As another example and not by way of limitation, continuing with the prior example, the message may be stored for a specified period of time (e.g., 2 weeks), after which point the system 100, the external system 200, and the user devices 300A-300B may delete the message from the content data store.

In particular examples, privacy settings may allow a user to specify one or more geographic locations from which objects can be accessed. Access or denial of access to the objects may depend on the geographic location of a user who is attempting to access the objects. As an example and not by way of limitation, a user may share an object and specify that only users in the same city may access or view the object. As another example and not by way of limitation, a first user may share an object and specify that the object is visible to second users only while the first user is in a particular location. If the first user leaves the particular location, the object may no longer be visible to the second users. As another example and not by way of limitation, a first user may specify that an object is visible only to second users within a threshold distance from the first user. If the first user subsequently changes location, the original second users with access to the object may lose access, while a new group of second users may gain access as they come within the threshold distance of the first user.

In particular examples, the system 100, the external system 200, and the user devices 300A-300B may have functionalities that may use, as inputs, personal or biometric information of a user for user-authentication or experience-personalization purposes. A user may opt to make use of these functionalities to enhance their experience on the online social network. As an example and not by way of limitation, a user may provide personal or biometric information to the system 100, the external system 200, and the user devices 300. The user's privacy settings may specify that such information may be used only for particular processes, such as authentication, and further specify that such information may not be shared with any external system or used for other processes or applications associated with the system 100, the external system 200, and the user devices 300. As another example and not by way of limitation, the system 100, the external system 200, and the user devices 300A-300B may provide a functionality for a user to provide voice-print recordings to the online social network. As an example and not by way of limitation, if a user wishes to utilize this function of the online social network, the user may provide a voice recording of his or her own voice to provide a status update on the online social network. The recording of the voice-input may be compared to a voice print of the user to determine what words were spoken by the user. The user's privacy setting may specify that such voice recording may be used only for voice-input purposes (e.g., to authenticate the user, to send voice messages, to improve voice recognition in order to use voice-operated features of the online social network), and further specify that such voice recording may not be shared with any external system or used by other processes or applications associated with the system 100, the external system 200, and the user devices 300. As another example and not by way of limitation, the system 100, the external system 200, and the user devices 300A-300B may provide a functionality for a user to provide a reference image (e.g., a facial profile, a retinal scan) to the online social network. The online social network may compare the reference image against a later-received image input (e.g., to authenticate the user, to tag the user in photos). The user's privacy setting may specify that such voice recording may be used only for a limited purpose (e.g., authentication, tagging the user in photos), and further specify that such voice recording may not be shared with any external system or used by other processes or applications associated with the system 100, the external system 200, and the user devices 300.

In particular examples, changes to privacy settings may take effect retroactively, affecting the visibility of objects and content shared prior to the change. As an example and not by way of limitation, a first user may share a first image and specify that the first image is to be public to all other users. At a later time, the first user may specify that any images shared by the first user should be made visible only to a first user group. The system 100, the external system 200, and the user devices 300A-300B may determine that this privacy setting also applies to the first image and make the first image visible only to the first user group. In particular examples, the change in privacy settings may take effect only going forward. Continuing the example above, if the first user changes privacy settings and then shares a second image, the second image may be visible only to the first user group, but the first image may remain visible to all users. In particular examples, in response to a user action to change a privacy setting, the system 100, the external system 200, and the user devices 300A-300B may further prompt the user to indicate whether the user wants to apply the changes to the privacy setting retroactively. In particular examples, a user change to privacy settings may be a one-off change specific to one object. In particular examples, a user change to privacy may be a global change for all objects associated with the user.

In particular examples, the system 100, the external system 200, and the user devices 300A-300B may determine that a first user may want to change one or more privacy settings in response to a trigger action associated with the first user. The trigger action may be any suitable action on the online social network. As an example and not by way of limitation, a trigger action may be a change in the relationship between a first and second user of the online social network (e.g., “un-friending” a user, changing the relationship status between the users). In particular examples, upon determining that a trigger action has occurred, the system 100, the external system 200, and the user devices 300A-300B may prompt the first user to change the privacy settings regarding the visibility of objects associated with the first user. The prompt may redirect the first user to a workflow process for editing privacy settings with respect to one or more entities associated with the trigger action. The privacy settings associated with the first user may be changed only in response to an explicit input from the first user, and may not be changed without the approval of the first user. As an example and not by way of limitation, the workflow process may include providing the first user with the current privacy settings with respect to the second user or to a group of users (e.g., un-tagging the first user or second user from particular objects, changing the visibility of particular objects with respect to the second user or group of users), and receiving an indication from the first user to change the privacy settings based on any of the methods described herein, or to keep the existing privacy settings.

In particular examples, a user may need to provide verification of a privacy setting before allowing the user to perform particular actions on the online social network, or to provide verification before changing a particular privacy setting. When performing particular actions or changing a particular privacy setting, a prompt may be presented to the user to remind the user of his or her current privacy settings and to ask the user to verify the privacy settings with respect to the particular action. Furthermore, a user may need to provide confirmation, double-confirmation, authentication, or other suitable types of verification before proceeding with the particular action, and the action may not be complete until such verification is provided. As an example and not by way of limitation, a user's default privacy settings may indicate that a person's relationship status is visible to all users (e.g., “public”). However, if the user changes his or her relationship status, the system 100, the external system 200, and the user devices 300A-300B may determine that such action may be sensitive and may prompt the user to confirm that his or her relationship status should remain public before proceeding. As another example and not by way of limitation, a user's privacy settings may specify that the user's posts are visible only to friends of the user. However, if the user changes the privacy setting for his or her posts to being public, the system 100, the external system 200, and the user devices 300A-300B may prompt the user with a reminder of the user's current privacy settings of posts being visible only to friends, and a warning that this change will make all of the user's past posts visible to the public. The user may then be required to provide a second verification, input authentication credentials, or provide other types of verification before proceeding with the change in privacy settings. In particular examples, a user may need to provide verification of a privacy setting on a periodic basis. A prompt or reminder may be periodically sent to the user based either on time elapsed or a number of user actions. As an example and not by way of limitation, the system 100, the external system 200, and the user devices 300A-300B may send a reminder to the user to confirm his or her privacy settings every six months or after every ten photo posts. In particular examples, privacy settings may also allow users to control access to the objects or information on a per-request basis. As an example and not by way of limitation, the system 100, the external system 200, and the user devices 300A-300B may notify the user whenever an external system attempts to access information associated with the user, and require the user to provide verification that access should be allowed before proceeding.

What has been described and illustrated herein are examples of the disclosure along with some variations. The terms, descriptions, and figures used herein are set forth by way of illustration only and are not meant as limitations. Many variations are possible within the scope of the disclosure, which is intended to be defined by the following claims—and their equivalents—in which all terms are meant in their broadest reasonable sense unless otherwise indicated.

1. A system, comprising:
a processor; and
a memory storing instructions, which when executed by the processor, cause the processor to:
receive a first candidate server from an available resource finder and a second candidate server from a resource optimizer;
implement a server allocator to prioritize use of one of the first candidate server and the second candidate server; and
receive feedback regarding the prioritized use of one of the first candidate server and the second candidate server.

2. The system of claim 1, wherein the resource optimizer comprises a deep reinforcement learning model.

3. The system of claim 1, wherein the feedback indicates if the second candidate server was used for container placement.

4. The system of claim 1, wherein a request to receive the first candidate server from the available resource finder and a request to receive the second candidate server from the resource optimizer are transmitted in parallel.

5. The system of claim 1, wherein the instructions, which when executed by the processor, cause the processor to:
receive a request to initialize a container; and
prioritize the second candidate server if the second candidate server is valid.

6. The system of claim 1, wherein the instructions, which when executed by the processor, cause the processor to implement a hybrid scheduler to address a time-dependency tradeoff, the hybrid scheduler comprising the server allocator, the resource optimizer, and the available resource finder.

7. The system of claim 1, wherein the instructions, which when executed by the processor, cause the processor to evaluate a similarity across two versions of recurrently trained distributed inference models.

8. A method of serving distributed inference deep learning (DL) models in serverless computing, comprising:
receiving a first candidate server from an available resource finder and a second candidate server from a resource optimizer;
implementing a server allocator to prioritize use of one of the first candidate server and the second candidate server; and
receive feedback regarding the prioritized use of one of the first candidate server and the second candidate server.

9. The method of claim 8, wherein the resource optimizer comprises a deep reinforcement learning model.

10. The method of claim 8, wherein the feedback indicates if the second candidate server was used for container placement.

11. The method of claim 8, wherein a request to receive the first candidate server from the available resource finder and a request to receive the second candidate server from the resource optimizer are transmitted in parallel.

12. The method of claim 8, further comprising:
receiving a request to initialize a container; and
prioritizing the second candidate server if the second candidate server is valid.

13. The method of claim 8, further comprising evaluating a similarity across two versions of recurrently trained distributed inference models.

14. The method of claim 8, further comprising implementing a hybrid scheduler to address a time-dependency tradeoff, the hybrid scheduler comprising the server allocator, the resource optimizer, and the available resource finder.

15. A non-transitory computer-readable storage medium having an executable stored thereon, which when executed instructs a processor to:
receive a request to initialize a container;
receive a first candidate server from an available resource finder and a second candidate server from a resource optimizer;
implement a server allocator to prioritize use of one of the first candidate server and the second candidate server; and
receive feedback regarding the prioritized use of one of the first candidate server and the second candidate server.

16. The non-transitory computer-readable storage medium of claim 15, wherein the resource optimizer comprises a deep reinforcement learning model.

17. The non-transitory computer-readable storage medium of claim 15, wherein the first candidate server and the second candidate server are the same.

18. The non-transitory computer-readable storage medium of claim 15, wherein a request to receive the first candidate server from the available resource finder and a request to receive the second candidate server from the resource optimizer are transmitted in parallel.

19. The non-transitory computer-readable storage medium of claim 15, wherein the executable when executed instructs a processor to prioritize the second candidate server if the second candidate server is valid.

20. The non-transitory computer-readable storage medium of claim 15, wherein a hybrid scheduler comprises the server allocator, the resource optimizer, and the available resource finder.
